(19) United States
(12) Patent Application Publication
(10) Pub. No.: US 2023/0341644 A1
(43) Pub. Date: Oct. 26, 2023

(54) OPTICAL GROUND WIRE DESIGN WITH SUPERIOR PERFORMANCE IN IMPULSE NOISE ENVIRONMENTS

(71) Applicant: University of Florida Research Foundation, Inc., Gainesville, FL (US)

(72) Inventors: Robert Christian Moore, Gainesville, FL (US); William C. Snider, Gainesville, FL (US); Joshua Santos, Gainesville, FL (US); David R. Doucet, Almonte (CA); Doug W. Charlton, Ottawa (CA)

(21) Appl. No.: 18/138,193

(22) Filed: Apr. 24, 2023

Related U.S. Application Data
(60) Provisional application No. 63/334,425, filed on Apr. 25, 2022.

(51) Int. Cl. G02B 6/44

(52) U.S. Cl. CPC G02B 6/4422

(57) ABSTRACT

Various examples are provided related to optical ground wire (OPGW) designs and mitigation of impulse effects. In one example, an optical ground cable includes one or more inner optical fiber; and a shield surrounding the one or more inner optical fiber. The shield includes a shield material have a skin-depth less than a skin-depth of aluminum which can improve rejection of intrusive signals and communications capabilities. Conductivity of the shield material can be greater than the conductivity of aluminum and permeability of the shield material can be greater than the permeability of aluminum.

### CROSS REFERENCE TO RELATED APPLICATIONS

This application claims priority to, and the benefit of, co-pending U.S. provisional application entitled “Optical Ground Wire Design with Superior Performance in Impulse Noise Environments” having Ser. No. 63/334,425, filed Apr. 25, 2022, which is hereby incorporated by reference in its entirety.

### BACKGROUND

Optical ground wire (OPGW) is a grounding wire found in overhead power lines which has an optical fiber channel inside it. The OPGW above the overhead power lines serves two main purposes: to shield the associated power lines from lightning, and to house a fiber channel for optical fiber data communications. For coherent optical communications interfaces, these fiber data communications rely on accurate optical signal polarization measurements. Factors such as weather conditions and power line currents, among others, can affect state of polarization (SOP) fluctuations, which are often slow and manageable. A direct lightning strike to the OPGW, however, can cause rapid and difficult to manage changes to the perceived SOP of the optical signal within.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates an example of a transmission line model, in accordance with various embodiments of the present disclosure.

FIGS. 2A-2D illustrate examples of simulations varying the lightning current rise time and strike location, in accordance with various embodiments of the present disclosure.

FIG. 3 illustrates an example of an optical ground wire (OPGW), in accordance with various embodiments of the present disclosure.

FIG. 4 illustrates a comparison of optical signal rotation with different shielding-core materials, in accordance with various embodiments of the present disclosure.

FIG. 5 illustrates a cross-section of an example of an optical fiber shielded with a small skin-depth material, in accordance with various embodiments of the present disclosure.

### DETAILED DESCRIPTION

Disclosed herein are various examples related to optical ground wire (OPGW) designs and mitigation of impulse effects. The optical fiber portion of an OPGW is typically encased in an aluminum shield to keep out intrusive signals, such as those resulting from lightning strikes to the OPGW. The intrusive signals can induce state of polarization changes on the optical signal via the Faraday effect, which can negatively impact communication and other applications using these optical signals. The use of a material with smaller skin-depth for shielding the optical fiber can improve rejection of intrusive signals and communications capabilities. The skin-depth of a material is inversely proportional to the square-root of the product of the material's conductivity and permeability. An OPGW design is presented that properly shields the optical fiber using a material with a small skin-depth using materials with a higher product of permeability and conductivity. Results of a transmission line model used to calculate the state of polarization (SOP) change (SOP_{Δ}) induced in an optical signal propagating in an OPGW are presented. The

Faraday effect as it relates to OPGW design parameters is discussed and a lighting current model, transmission line model, and simulation results are presented. Reference will now be made in detail to the description of the embodiments as illustrated in the drawings, wherein like reference numbers indicate like parts throughout the several views.

OPGW designs vary widely but, in general, share three physical elements: 1) a conductive element, 2) a tensile strength element, and 3) a fiber portion. A common OPGW design comprises exterior high-tensile strength aluminum-clad steel strands wrapped helically around an aluminum core; within the aluminum core are fiber strands. If the current of a given lightning strike to the cable follows the helical pattern of the exterior conductors, then that current may create a magnetic field within the fiber, along the path of the optical signal's propagation. This field along the propagation path subjects the optical signal to a rotation produced by the Faraday effect.

### The Faraday Effect

The Faraday effect is responsible for the SOP_{Δ} induced in an optical signal propagating in a fiber in the presence of a magnetic field. When a magnetic field has a component along the propagation path of an optical signal, the SOP of the optical signal will experience an angular shift given by:

SOP_{Δ}=V_{eff}∫₀^{l}B(z)dz (1)

where l is the length of the interaction region, B is the path-aligned magnetic flux density, z the optical signal path coordinate, and V_{eff}=(1.42×10⁻²⁹)ν². Here, ν is the optical frequency. The constant 1.42×10⁻²⁹ is an empirical value for standard silica fibers. Assuming the current propagates along the helical pattern of the outer conductors, an axial magnetic field results, which can be approximated by:

$$B = \frac{μ I}{π D} sin ( arctan ( \frac{D}{P} ) ) \qquad ( 2 )$$

where l is the current, D is the diameter of the outer conductor strand, P is the pitch of the strands, and μ is the permeability of the center material (assumed here to be μ₀=4π×10⁻⁷ H/m).

The SOP_{Δ} can then be calculated by substituting the expression for B in Eq. 2, into the integral in Eq. 1. Because the B-field is a function of time and space, the SOP_{Δ} is also a function of time and space (position along the OPGW).

### Lightning and Transmission Line Modeling

Lightning Current Model. An average negative cloud-to-ground lightning return stroke has a peak current of 30 kA but return strokes with peak currents over 200 kA can occur. The return stroke current risetime is typically between 1 ms and 5 ms with a much longer recovery. The Heidler model can be used for the time-domain lightning channel current:

$$I ( t ) = \frac{{I}_{max}}{η} ( \frac{{( \frac{t}{{τ}_{1}} )}^{n}}{1 + {( \frac{t}{{τ}_{1}} )}^{n}} ) {e}^{\frac{- t}{{τ}_{2}}} \qquad ( 3 )$$

where τ₁ and τ₂ are the current rise and fall times, and π is a scaling factor (chosen here to be 10). η modifies the magnitude of the current to ensure that the value of Iₘₐₓ is the actual peak current. It has been shown that lightning strike location affects SOP; whether lightning current risetime or peak current also affect SOP will be evaluated.

Transmission Line Model. A wire-over-a-ground-plane transmission line model can be used to simulate the lightning current propagation along the OPGW. The current on the transmission line, I(z), follows a phasor-domain wave equation:

$$\frac{{\partial }^{2} I ( z )}{\partial {z}^{2}} = {γ}^{2} I ( z ) where γ = \sqrt{( R + j ω L ) ( G + j ω C )} \qquad ( 4 )$$

and R is resistance, L is inductance, C is shunt capacitance, and G is the shunt conductance, all expressed per unit length. This wave equation provides a traveling current wave solution of the form I(z)=I₍₊₎e^{-γt}−I₍₋₎e^{+γt}, where I₍₊₎ and I₍₋₎ are the forward and backward traveling current waves. These current waves will propagate down the transmission line and reflect at junctions with coefficient Γ_{L}=(Z₀−Z_{L})/(Z₀+Z_{L}), where Z₀ and Z_{L} are the characteristic and load impedances.

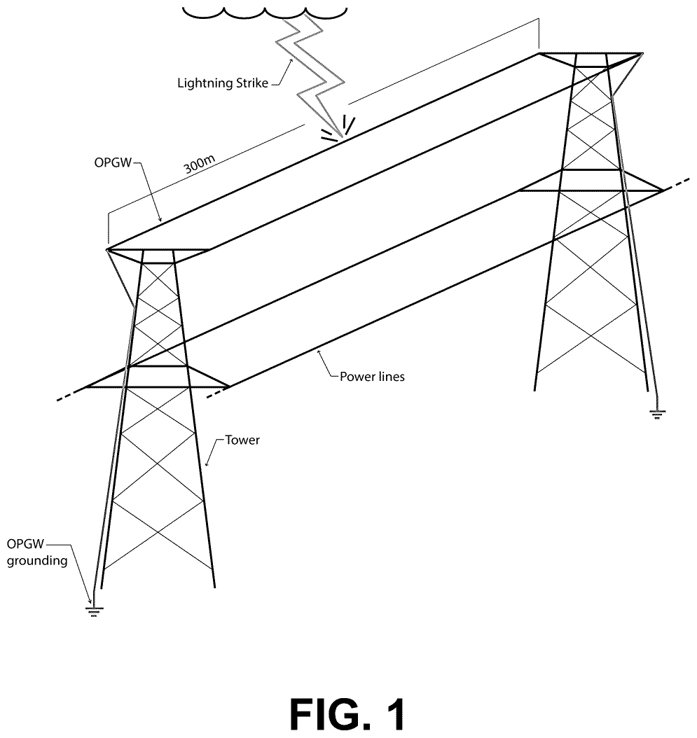

The model used in this evaluation comprises a 300 m long transmission line with a characteristic impedance of 300 ohms, terminated at both ends by a 300 ohm load in parallel with another 300 m length of cable, as depicted in FIG. 1. This work considers the lightning current waveforms launched in opposite directions, as well as three reflections from the grounding towers junctions. Equations were solved numerically in the frequency domain and converted to the time domain using the inverse Fourier Transform.

Simulation Results. The simulations assume use of a fiber with an index of refraction of 1.45, which produces a propagation velocity of ⅔ the speed of light. The time to travel 300 m at this velocity is 1.5 ms, which is on the order of the lightning current risetime. Three variations were considered: 1) for fixed lightning current rise time (2.5 ms) and strike location (50 m), the lightning peak current varied from 1 to 100 kA, 2) for fixed lightning peak current (30 kA) and strike location (50 m), the lightning current rise time varied from 1 ms to 5 ms, and 3) for fixed lightning peak current (30 kA) and lightning current rise time (2.5 ms), the strike location varied from 50 to 250 m.

Simulations varying the lightning peak current indicate that the SOP_{Δ} and dSOP_{Δ}/dt depend linearly on peak current, as expected. These results are not shown in the interest of brevity.

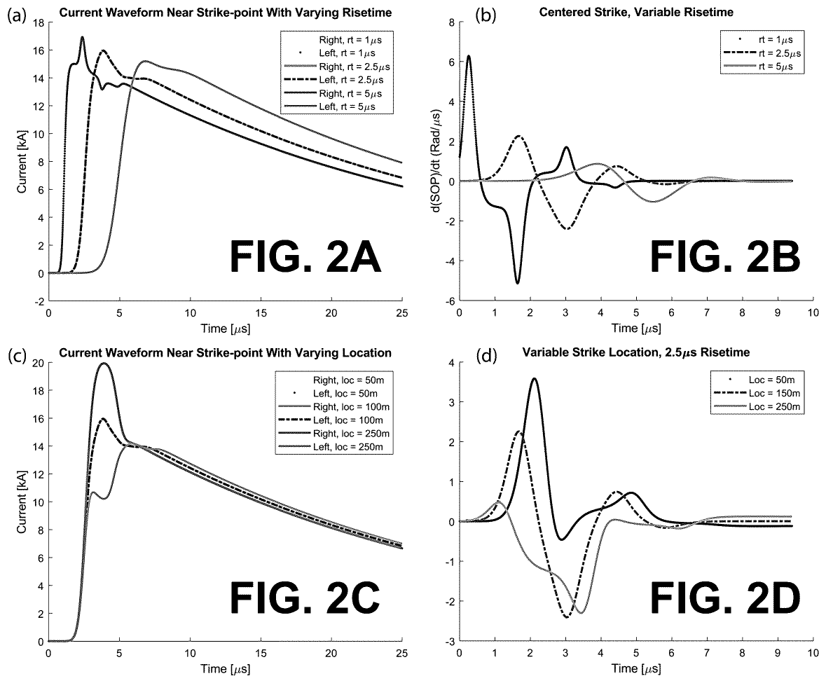

Referring to FIGS. 2A and 2B, shown are examples of simulations varying the lightning current rise time. The transmission line current of FIG. 2A exhibits more interference (due to reflections) for faster current rise times. The associated dSOP_{Δ}/dt in FIG. 2B, however, exhibit peaks that scale inversely with current rise time: shorter rise times yield larger peaks.

In FIGS. 2C and 2D, examples of simulations varying strike location are shown. As illustrated, strike location has an important impact on the current waveform in FIG. 2C and on the peak value of dSOP_{Δ}/dt in FIG. 2D. When 50 m from the left tower, the dSOP_{Δ}/dt is nearly 5 rad/ms, but when 250 m from the left tower the SOP_{Δ} is just 0.4 rad/ms. Clearly, the strike location has a strong impact on SOP_{Δ}.

A transmission line model was used to calculate the dSOP_{Δ}/dt of an optical signal traveling within an OPGW that is struck by lightning. The simulations indicate that the SOP_{Δ} can be significant, with changes on the order of published experimental observations. Furthermore, the lightning current risetime, strike location, and peak current (not shown) can significantly affect the perceived SOP_{Δ}. In this study, the fastest risetime (1 ms), and the strike point farthest from the optical measurement point (50 m location), exhibited the most extreme peak rate of SOP_{Δ}.

### OPGW Design

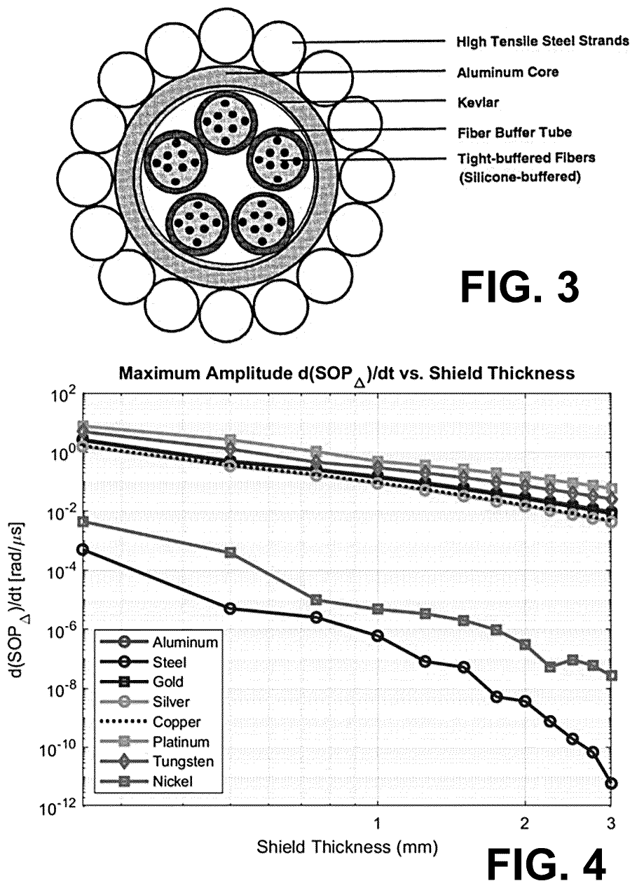

FIG. 3 illustrates an example of the construction of an OPGW. Coherent optical communications suffer from lightning strikes, whose lower frequency components leak into the fiber channel through the aluminum core, causing signal disruption in the optical fiber. The signal disruption is a rotation of the state of polarization in time (dSOP_{Δ}/dt). FIG. 3 illustrates a design implementation used above. The experiment was carried out with a different core material and found that conducting (carbon) steel actually provided a better shielding for the fiber portion, due to its comparable conductivity (σ) to aluminum, but significantly higher permeability (μ). The skin-depth (penetration of electromagnetic fields depth) is inversely proportional to both of these material properties; for comparison, aluminum has {σ=36.9 MS/m, μ=1.00002μ₀} and carbon steel has {σ=7.56 MS/m, μ=4000μ₀}.

In addition, carbon steel has a higher melting temperature than aluminum, but is more susceptible to corrosion. Carbon steel is stronger, harder, and more dent resistant, but also denser (heavier) than aluminum. The higher the carbon content in carbon steel, the heavier, harder, and denser it becomes. Steel is typically cheaper than aluminum (per pound), and both are 100% recyclable. Carbon steel also has a lower thermal expansion coefficient and higher melting point than aluminum, which may offer benefit concerning damage by direct lightning strikes to the OPGW. A steel core can offer a cheaper, stronger, and better shielded solution for OPGWs housing coherent fiber communications signals.

Several other materials can be utilized as a shielding core. FIG. 4 illustrate a comparison of optical signal rotation (dSOP_{Δ}/dt) given the different shielding-core materials. Steel likely offers the cheapest solution and certainly beats all other options from a shielding perspective. The other materials such as Nickel can be used to provide shielding, but (aside from aluminum or steel) may be prohibitively expensive for OPGW. For coherent optical communications, a carbon steel shielding can offer a better protection than aluminum when it comes to protecting the inner optical fiber signal's polarization from state changes induced by lightning strikes.

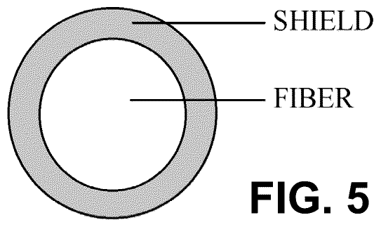

A variety of cable constructions satisfy the principles of the disclosure. For example, the cross-section of a simple optical fiber used for communications and based on the same principles is illustrated in FIG. 5. Such a cable can be used to relay messages between various parts of devices that may be exposed to impulsive noise environments. Optical fiber communications in important applications, such as self-driving vehicles, can be impacted by nearby lightning impulses. The electromagnetic impulses radiated by nearby lightning can induce the Faraday effect within an unshielded fiber and disrupt communications. The shield material in FIG. 5 is a small skin depth material, which reduces the magnitude of the field that makes it to the fiber and reduces the Faraday effect. Applications that rely on fiber communications would benefit from this type of shielding.

In military settings, such as for communications cables used in helicopters, planes, ships, cars, or even command centers, unshielded fiber cables have long been thought to be resistant to electromagnetic interference, but optical signal modulation schemes that are affected by SOP changes are susceptible to impulsive electromagnetic interference, whether produced by lightning or by nuclear detonations, for instance. The electromagnetic pulse radiated by lightning exhibits rise times on the order of a microsecond, whereas the electromagnetic pulses radiated by a nuclear detonation exhibit rise times on the order of a picosecond, resulting in higher frequency content. The material surrounding the fiber in FIG. 5 is a small skin depth material that properly protects the fiber from this electromagnetic interference, especially for the higher frequency content of nuclear electromagnetic pulses.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

The term “substantially” is meant to permit deviations from the descriptive term that don't negatively impact the intended purpose. Descriptive terms are implicitly understood to be modified by the word substantially, even if the term is not explicitly modified by the word substantially.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. An optical ground cable, comprising:
one or more inner optical fiber; and
a shield surrounding the one or more inner optical fiber, the shield comprising a shield material have a skin-depth less than a skin-depth of aluminum.

2. The optical ground cable of claim 1, wherein the shield material of the shield is steel.

3. The optical ground cable of claim 1, wherein the shield material of the shield is nickel.

4. The optical ground cable of claim 1, wherein conductivity of the shield material is greater than conductivity of aluminum.

5. The optical ground cable of claim 4, wherein conductivity of the shield material is greater than 40 MS/m.

6. The optical ground cable of claim 1, wherein permeability of the shield material is greater than permeability of aluminum. 7 The optical ground cable of claim 6, wherein the permeability of the shield material is about 100μ₀ or greater.

8. The optical ground cable of claim 7, wherein the permeability of the shield material is about 500μ₀ or greater.

9. The optical ground cable of claim 8, wherein the permeability of the shield material is about 1000μ₀ or greater.

10. The optical ground cable of claim 9, wherein the permeability of the shield material is about 2000μ₀ or greater.

11. The optical ground cable of claim 10, wherein the permeability of the shield material is about 4000μ₀ or greater.

12. The optical ground cable of claim 1, wherein a thickness of the shield material is a multiple of the skin depth of the shield material.

13. The optical ground cable of claim 1, comprising a plurality of inner optical fibers within the shield.

14. The optical ground cable of claim 1, comprising a protective sheath surrounding the shield.
